(19) United States
(12) Patent Application Publication
(10) Pub. No.: US 2008/0134132 A1
(43) Pub. Date: Jun. 5, 2008

(54) Developing Software Components Based on Brain Lateralization

(75) Inventors: Vladimir Sadovsky, Bellevue, WA (US); Jonathan R. Schwarz, Boise, ID (US); Rebecca A. Norlander, Seattle, WA (US); Michael D. Stokes, Eagle, ID (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/565,495

(22) Filed: Nov. 30, 2006

(51) Int. Cl. G06F 9/44; G06F 9/45

(52) U.S. Cl. 717/101; 717/136

(57) ABSTRACT

A software design process includes three elements—an object/component driven element, a situation/scenario driven element, and an arbitrator/communicator element that is logically interposed and serves as an intermediary between the object/component driven and the situation/scenario driven elements. Through an iterative communication process overseen by the arbitrator/communicator, software design can take place and be measured against a metric. The communication process overseen and implemented by the arbitrator/communicator can allow ideas and developments provided by one element to be translated into a format that the other element understands. Once the metric has been achieved, the design process can be terminated.

### BACKGROUND

Developing software is a complicated process. In the past, some of the approaches that have been used in this process include a scenario or market driven approach and an engineering driven approach.

Scenario or market driven approaches can, and often do, lead to focusing too much on the particular scenario and not enough on the flexibility of the components being designed. This approach can be very deterministic and leads to inflexibilities. Specifically, this type of approach is not well suited for handling changes associated with the competitive environment, ecosystem or the economy after the initiation of the process. Thus, changes such as those mentioned above often result in a complete reworking of the system being designed. Needless to say, this can be a very inefficient process.

Engineering driven approaches, on the other hand, tend to focus primarily if not completely on the components being designed and hence, tend to ignore situations and dependencies. Specifically, many times engineering approaches discount or completely ignore customer needs, scenarios, and situations associated with a component's or system's use. Accordingly, components designed in this way can experience difficulty when placed into the stream of commerce.

### SUMMARY

A software design process includes three elements—an object/component driven element, a situation/scenario driven element, and an arbitrator/communicator element that is logically interposed between the object/component driven and the situation/scenario driven elements. In practice, the object/component driven element represents and is associated with software architects, designers and engineers. Likewise, the situation/scenario driven element represents and is associated with end users, vendors and/or customers of the software being designed. The arbitrator/communicator serves as an intermediary between these two elements. The arbitrator/communicator element can develop a metric against which the software design process is measured. Once one of these elements has been seeded with an initial idea, as intermediary, the arbitrator/communicator can mediate the evolution of the idea that is contributing to the software being designed, as well as iteratively translate back and forth between the object/component driven element and the situation/scenario driven element. Once the metric has been achieved, the arbitrator/communicator element can conclude the design process.

### BRIEF DESCRIPTION OF THE DRAWINGS

FIG. 1 illustrates the notion of the left and right brain and gives a few examples of the types of thinking that each side does.

FIG. 2 illustrates three exemplary groups involved in the development of software in accordance with one embodiment.

FIG. 3 illustrates an exemplary design process utilizing brain lateralization in accordance with one embodiment.

### DETAILED DESCRIPTION

Overview

A software design process includes three elements—an object/component driven element, a situation/scenario driven element, and an arbitrator/communicator element that is logically interposed between the object/component driven and the situation/scenario driven elements. In practice, the object/component driven element represents and is associated with software architects, designers and engineers. Likewise, the situation/scenario driven element represents and is associated with end users, vendors and/or customers of the software being designed. The arbitrator/communicator serves as an intermediary between these two elements. The arbitrator/communicator element can develop a metric against which the software design process is measured. Once one of these elements has been seeded with an initial idea, as intermediary, the arbitrator/communicator can mediate the evolution of the idea that is contributing to the software being designed, as well as iteratively translate back and forth between the object/component driven element and the situation/scenario driven element. Once the metric has been achieved, the arbitrator/communicator element can conclude the design process.

In the illustrated and described embodiments, the software design process is based, at least in part, on brain lateralization—which is the way that the brain communicates between its two distinct hemispheres. In the discussion that follows, a brief explanation of brain lateralization is provided, followed by a discussion of the software design process that incorporates its principles.

Brain Lateralization

Experimentation has shown that the two different sides or hemispheres of the brain are responsible for different manners of thinking.

For example, the left brain tends to look at parts, while the right brain tends to look at wholes. The left brain is logical, sequential, rational, analytical, and objective. The right brain, on the other hand, is random, intuitive and holistic. The right brain is good at synthesizing, being subjective and processing relationship information.

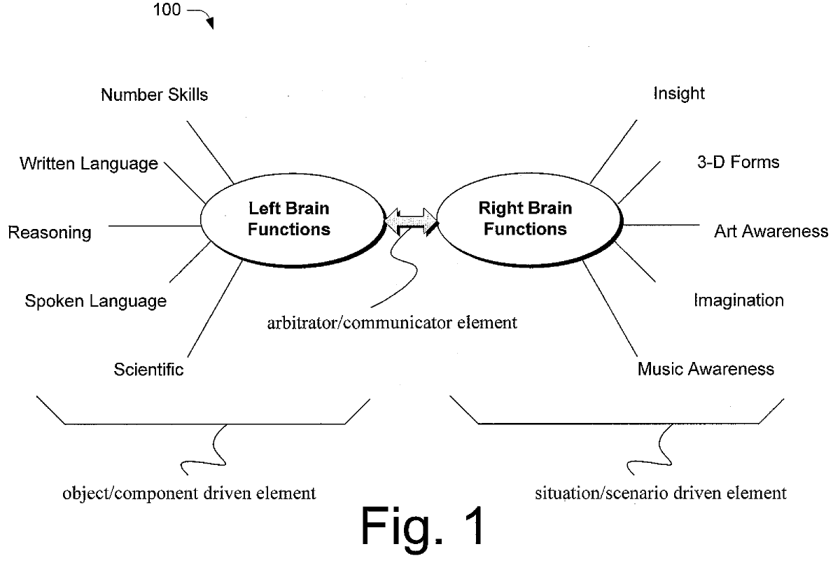

FIG. 1 illustrates, generally at 100, the notion of the left and right brain and gives a few examples of the types of thinking that each side does. For example, the left brain is responsible for number skills, written language, reasoning, spoken language and scientific thought. The right brain, on the other hand, is responsible for insight, 3-D formulation, art awareness, imagination and music awareness.

Most individuals have a distinct preference for one of these styles of thinking. Some, however, are more whole-brained and equally adept at both modes. Left-brain scholastic subjects focus on logical thinking, analysis, and accuracy. Right-brained scholastic subjects, on the other hand, focus on aesthetics, feeling, and creativity.

Consider now how the left and right brains map to the entities that are involved in the software design process. Specifically, software architects, designers and engineers tend to map to and are properly represented by the left side of the brain. Hence, in the figure, this side of the brain is associated with the object/component driven element described above. End users, vendors and customers tend to map to and are properly represented by the right side of the brain. Hence, in the figure, this side of the brain is associated with the situation/scenario driven element described above. The communication function between the two sides of the brain maps to the arbitrator/communicator element described above.

When one analogizes the software design process to the process of how the brain communicates, it has become apparent to the inventors that a method of communication, not unlike that of the corpus callosum (which effects the brain's communication between hemispheres), is desirable in order to facilitate communication between two distinct viewpoints—that of the engineers/designers, and that of the end users/customers/vendors—in order to derive highly functional software components, such as platform components, that will enable high levels of innovation with minimal schedule and situational change risk.

Software Design Process Incorporating Brain Lateralization

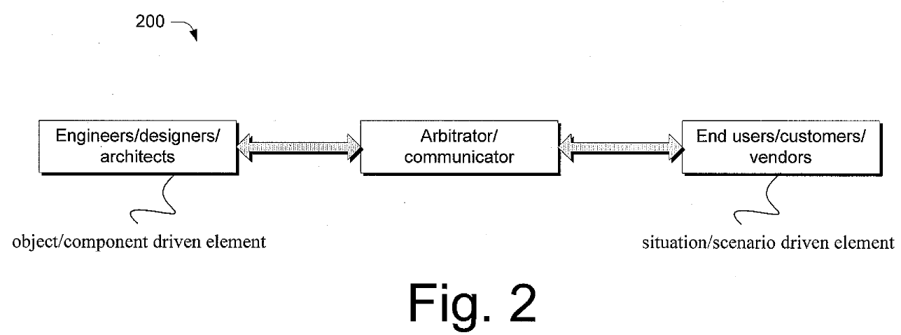

FIG. 2 illustrates, generally at 200, three exemplary groups involved in the design of software, such as platform components, generally at 200. In this example, engineers, designers and software architects represent the object/component driven element of the design process; and end users, customers and vendors represent the situation/scenario driven element of the design process. Communication between the two takes places via an arbitrator/communicator.

One assumption in the above scenario, and hence one of the reasons for the presence of the arbitrator/communicator, is that the object/component driven element or group cannot communicate effectively with the situation/scenario driven element or group. Hence, the arbitrator/communicator serves as a communication intermediary between the two groups.

In this regard, the arbitrator/communicator can perform a number of functions. For example, the arbitrator/communicator can establish various metrics that the group, as a whole, is to achieve. This metric can be based on a desired outcome or functionality for the software. Once the metric is established, the arbitrator/communicator can seed one of the group's elements with an initial idea associated with this metric and then, through an iterative process, communicate back and forth between the elements until the metric is achieved or the design process is concluded.

Part of this communication process can involve translating each iteration from one group into a form that the other group can understand. For example, the situation/scenario driven element may develop a list of features or desired functionality for a particular software package under development. The arbitrator/communicator can then evaluate the list and translate it into a format that is understood by the object/component driven element. Likewise, the object/component driven element may develop a list of components that achieve the objectives of the situation/scenario driven element. The arbitrator/communicator can then translate this list into a description of how the components can achieve the objectives desired by the situation/scenario element.

As a somewhat tangible example of how this process can work, consider the following. In one scenario involving color management technology, a program manager acts as an arbitrator/communicator and is provided an identified opportunity by a product planner to improve color management for the photographic community. The program manager assembles two separate teams, one is a group of photographers that provide the situation/scenario elements and the other is a set of developers, architects and testers. The arbitrator/communicator sets, as a metric, the definition of a feature that will be viewed as compelling or a “must have” by the photographic community while viewed as implementable and testable within schedule and resource constraints by the developer community. The arbitrator/communicator seeds the photographers by asking what the most frustrating element in their current color management workflows is. The arbitrator/communicator leads a purely scenario/situation driven discussion without concern on feasibility or implementability within this community.

The initial result is that the photographers identify the lack of a central color control panel UI as their biggest frustration. The arbitrator/communicator takes this idea to the developers and enables an architectural discussion on whether such a component is implementable and what it would look like. The developers provide a sketch of what a solution would look like with initial resource costs. The arbitrator/communicator takes this sketch back to the photographers which leads to many revisions and suggestions. This process is iterated until the photographers agree that the feature would be interesting and the developers agree that it is implementable.

Prior to final agreement, the arbitrator/communicator pushes the photographic community to determine whether the result of this effort would truly resolve their most frustrating issue and through this discussion and realization of potential solutions to the original question, they identify the inability to easily troubleshoot a color issue if something goes wrong as the true underlying reason they originally requested a common control panel. The arbitrator/communicator then takes this back to the developers and restarts the discussions. This process again iterates until a set of tracing and debugging components is designed in combination with an easy to use “wizard” that guides users to a process to verify each component in the color workflow is working as expected. The photography community validates this as truly compelling and the developer community validates it is implementable within the resource constraints. The arbitrator/communicator then declares that the metric is met and formalizes the feature design.

It can be important in this process for the arbitrator/communicator to not inject any of their own opinions with regard to the communication that takes place between the object/component driven element and the situation/scenario driven element. Rather, the arbitrator/communicator's purpose is to serve as an objective conveyor and translator of ideas from one group to the other.

In at least one embodiment, one goal of the above-described process is to design software, such as various software platforms, that are composed of robust, flexible components that enable families of scenarios to be solved. The target set of scenarios would constitute a subset of an entire set that can include scenarios not yet imagined and which go well beyond the target subset.

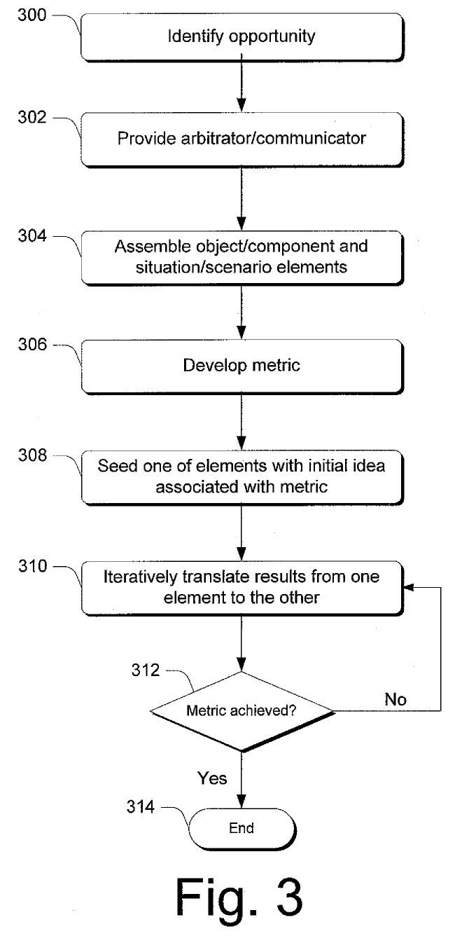

Consider now FIG. 3 which illustrates an exemplary design process utilizing brain lateralization in accordance with one embodiment.

Step 300 identifies an opportunity. This step can be performed in any suitable way. For example, an opportunity may manifest itself in the form of a demand or request from a customer or vendor for a particular type of software or functionality. Alternately or additionally, this step may manifest itself in an opportunity to land a new customer by offering to fulfill a particular need or demand they may have.

Step 302 provides an arbitrator/communicator that is to serve as a communication mechanism between object/component driven elements and situation/scenario elements that are to be, or have been assembled. In practice, the person who serves in this role should have the background and technical experience to effectively communicate with both groups—that is, both engineers/designers and end users/customers. In at least some embodiments, it is important, as mentioned above, for the arbitrator/communicator to remain unbiased and unopinionated during this process. That is, it is desirable for the process of communication and translation between the object/component driven and situation/scenario driven elements to be as objective as possible.

Step 304 assembles object/component driven elements and situation/scenario driven elements. This step can be performed in any suitable way. For example a particular customer may have a team of individuals who can serve as the process's situation/scenario driven elements. While this group may be aware of the problem that they are experiencing or scenario that they are wishing to address, they may not necessarily know the cause of the problem and/or may not necessarily be able to articulate the problem or scenario in a manner that will be understood and appreciated by the object/component driven element. As such, they serve as a good starting point for fleshing out the problems/scenarios in more detail. The object/component element can be assembled by the organization looking to act upon the identified opportunity. This group can include, by way of example and not limitation, engineers, software designers and software architects. In at least some embodiments, the person driving the assembly of these two elements can be the arbitrator/communicator.

Step 306 develops a metric which is essentially the goal that the design process is targeting. This step can be performed in any suitable way and by any suitable person. For example, the arbitrator/communicator can meet with the situation/scenario driven element to ascertain their particular circumstances and to attempt to understand their problem more fully. Once a particular problem is understood, the arbitrator/communicator can abstract the problem to develop a metric whose goal is, for example, to not only design software that addresses a particular scenario, but to design software that provides a robust collection of components that provide flexible solutions to scenarios that may be, as of the time of development, yet to be determined.

Once the metric has been developed, step 308 seeds one of the elements with an initial idea associated with the metric. In practice, this step may be performed by seeding the object/component driven element with an idea associated with the metric developed by the arbitrator/communicator.

The result of this process is that the object/component element then goes and begins initial design work. At a particular point in the design process, this element can meet with the arbitrator/communicator to articulate their design thus far. Responsive to this, step 310 iteratively translates the results from one element to the other element. For example, here the arbitrator/communicator can translate the initial design considerations into a format that is understood by the situation/scenario driven element and present the translated information to the situation/scenario driven element for evaluation. Once evaluated by the situation/scenario driven element, the arbitrator/communicator can ascertain, at step 312, whether the metric defined in step 306 has been met. If not, the method returns to step 310 and the iterative communication between the two elements continues.

If, on the other hand, the metric is achieved, step 314 terminates the process.

Example Scenario

In the following example, assume that the situation/scenario driven element is composed of a group of professional photographers who have been working with a particular image-processing software package for some time. Many of the photographers have indicated, over time, that they do not like working with particular interfaces of the software package. Thus, initially, the problem appears to be related to the software's interfaces. However, as the arbitrator/communicator explores this problem space more with the photographers, she learns that it is not the interface that is necessarily the problem, but rather the fact that the software requires the photographers to spend what they believe to be an inordinate amount of time at their computer and not behind their cameras. Thus, a problem begins to emerge—that of designing image processing software that mitigates the time demand placed on the photographer.

Further to this discussion, the arbitrator/communicator can query the photographers and distill from them the characteristics and properties associated with their time-demand problem. It might be that, through this discussion, the arbitrator/communicator learns of certain perceived inefficiencies with the software and suggestions of features that would alleviate these inefficiencies. Thus, the arbitrator/communicator can develop an appropriate metric as indicated above.

Armed with this knowledge, the arbitrator/communicator can translate the articulated problems and suggested features into an abstraction that the object/component driven element understands and seed this element with an initial idea associated with achieving the metric. The object/component driven element may return to the arbitrator/communicator with a list of components or software functionality that they believe will address and solve these problems. Responsively, the arbitrator/communicator can return to the situation/scenario driven element and present to this element the solution proposed by the object/component driven element.

The arbitrator can then iteratively communicate back and forth between these elements until the metric is achieved or the design process is concluded.

### CONCLUSION

A software design process has been described that includes three elements—an object/component driven element, a situation/scenario driven element, and an arbitrator/communicator element that is logically interposed and serves as an intermediary between the object/component driven and the situation/scenario driven elements. Through an iterative communication process overseen by the arbitrator/communicator, software design can take place and be measured against a metric. The communication process overseen and implemented by the arbitrator/communicator can allow ideas and developments provided by one element to be translated into a format that the other element understands. Once the metric has been achieved, the design process can be terminated. This approach can provide advantages in the form of leveraging the knowledge of both the object/component driven and situation/scenario driven elements, while ensuring that any dilutive effects due to blurring of the roles as between the elements are mitigated.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
identifying an opportunity associated with designing software;
providing an arbitrator/communicator who is to serve as an intermediary between an object/component driven element and a situation/scenario driven element composed of individual who are to use designed software;
assembling the object/component driven element, wherein said object/component driven element includes individuals who design software;
developing a metric associated with development of said software and against which design activities are to be measured;
seeding one of said elements with an idea associated with the metric; and
iteratively translating and communicating results from one element to another until the design process is terminated.

2. The method of claim 1, wherein the opportunity manifests itself in the form of a demand or request from a customer or vendor.

3. The method of claim 1, wherein the opportunity manifests itself in the form of a new customer.

4. The method of claim 1, wherein the situation/scenario driven element comprises one or more of end users, vendors, or customers of said software.

5. The method of claim 1, wherein said act of developing a metric is performed by the arbitrator/communicator.

6. The method of claim 5, wherein said metric is developed, at least in part, by ascertaining one or more problems associated with the situation/scenario driven element.

7. The method of claim 1, wherein the act of seeding is performed by seeding the object/component driven element.

8. The method of claim 1, wherein the design process is terminated responsive to achieving the metric.

9. A system comprising:
an object/component driven element comprising individuals associated with the design of software;
a situation/scenario driven element associated with individuals who use software designed by the object/component driven element; and
an arbitrator/communicator logically interposed between the object/component driven element and the situation/scenario driven element and serving as an unbiased communication intermediary between said two elements,
wherein the arbitrator/communicator iteratively communicates results achieved by said two elements between said two elements until a design metric is achieved.

10. The system of claim 9, wherein the arbitrator/communicator produces said design metric.

11. The system of claim 9, wherein the arbitrator/communicator seeds one of the elements with an idea associated with achieving the design metric.

12. The system of claim 9, wherein the arbitrator/communicator does not inject personal opinions about software design in the iterative communication that takes place between the two elements.

13. The system of claim 9, wherein the arbitrator/communicator translates information from one element into a form that the other element understands.

14. A method comprising:
providing an object/component driven element comprising individuals associated with the design of software;
providing a situation/scenario driven element associated with individuals who use software designed by the object/component driven element;
logically interposing an arbitrator/communicator between the object/component driven element and the situation/scenario driven element; and
using the arbitrator/communicator as an unbiased communication intermediary between said two elements, wherein the arbitrator iteratively communicates software design-related results achieved by said two elements between said two elements.

15. The method of claim 14, further comprising using the arbitrator/communicator to produce a design metric against which design activities are measured.

16. The method of claim 15 further comprising using the arbitrator/communicator to seed one of the elements with an idea associated with achieving the design metric.

17. The method of claim 14, wherein the arbitrator/communicator does not inject personal opinions in the iterative communication that takes place between the two elements.

18. The method of claim 14 further comprising using the arbitrator/communicator to translate information from one element into a form that the other element understands.
